(19) United States
(12) Patent Application Publication
(10) Pub. No.: US 2003/0053174 A1
(43) Pub. Date: Mar. 20, 2003

(54) Optical equalizing of chromatic and polarization mode dispersion

(76) Inventor: Harald Rosenfeldt, Hamburg (DE)

Correspondence Address: LADAS & PARRY, 224 SOUTH MICHIGAN AVENUE, SUITE 1200, CHICAGO, IL, 60604, US

(21) Appl. No.: 09/952,815

(22) Filed: Sep. 14, 2001

(51) Int. Cl. H04J 14/08; H04B 10/00

(52) U.S. Cl. 359/161; 359/140

(57) ABSTRACT

The present invention relates a method of influencing a group delay of an optical signal, comprising the steps of a: splitting a beam of the optical signal into n parts, each part traveling an optical path, n being a natural number greater zero, b: splitting all of the n parts into m subparts, each part traveling an optical path, m being a natural number greater zero, c: superimposing the kth subpart of at least two of the m subparts to a resulting kth superimposed part, k=1, d: repeating step c for k from 2 to m, e: performing steps b to d at least one time with at least two of the superimposed parts, f: using at least one of the resulting superimposed parts for influencing the group delay of the optical signal.

### BACKGROUND OF THE INVENTION

The present invention relates to optical influencing of an optical signal, especially to optical influencing of chromatic and polarization mode dispersion of an optical signal, especially to optical equalizing of chromatic and polarization mode dispersion of an optical signal.

The recent progress of high bit-rate optical transmission systems constantly raise the requirements of the quality of the transmission link. Major sources of signal impairments are chromatic dispersion (CD) and polarization mode dispersion (PMD) of optical fibers. CD causes the group velocity to vary with wavelength. The red components of an optical pulse are traveling slower than the blue components. As a consequence a short pulse is broadened causing inter-symbol-interference at the receiver if the amount is too high. In presence of PMD the optical signal splits up into two polarizations with different group velocities and in the case of higher-order PMD different group velocity dispersions. A common way to compensate for CD is to insert a certain length of dispersion compensating fiber (DCF) with an opposite sign of the dispersion coefficient. This method causes the dispersion coefficient to vanish at a certain wavelength while the compensation at other wavelengths is usually imperfect. However, CD and PMD of an optical fiber fluctuate due to changing environmental conditions (like temperature, atmospheric pressure etc.). The magnitude of those effects can cause significant performance reduction at bit rates higher than 10 Gbit/s.

Since next generation optical systems use bit rates as high as 40 Gbit/s they are getting more sensitive against distortions caused by CD or PMD. Therefore, PMD compensation has to be introduced into future transmission systems. But also requirements of passive CD-compensation are increased, e.g. when using the afore-mentioned dispersion-compensating fiber. Moreover, the dispersion tolerance is reduced to an amount in the order of temporal fluctuations of the CD. Transmission distance of an optical link can be increased significantly if the temporal fluctuations of PMD and CD are adaptively compensated. In the following paragraphs, the tunable CD- and PMD-compensating filters are sometimes referred to as optical CD- or PMD-equalizers.

Several tradeoffs are associated with prior-art realizations of CD- or PMD-equalizers. The most popular realizations of tunable CD-equalizers are based on fiber Bragg gratings. Examples are the works of M. J. Erro, M. A. G. Laso, T. Lopetegui, M. J. Garde, D. Benito, “Electrically tunable dispersion compensation in high bit rate TDM system using fibre Bragg gratings”, Electronics Letters 37(13), pp. 847-848 (2001), and of B. J. Eggleton, B. Mikkelsen, G. Raybon, A. Ahuja, J. A. Rogers, P. S. Westbrook, T. N. Nielsen, S. Stulz, K. Dreyer, “Tunable Dispersion Compensation in a 160 Gb/s TDM System by Voltage Controlled Fiber Grating”, Proc. ECOC 2000, Munich, Germany Vol. 1(3.2.1.), pp. 111-112 (2000), (in the following referred to as [5] and [6]). Those Bragg gratings usually suffer from group delay ripples which can cause severe signal distortions in high bit-rate systems.

In a fundamental article of G. Lenz, B. J. Eggleton, C. K. Madsen, R. E. Slusher, “Optical Delay Lines Based on Optical Filters”, IEEE journal of quantum electronics 37(4), pp. 525-532 (2001), (in the following referred to as [2]) the properties of optical delay lines based on optical filters, such as Bragg gratings are described. As a basic work the article discloses some of the inherent tradeoffs involved in generating large group delays using the known optical filters.

Another realization of tunable CD equalizers are asymmetric Fabry-Perot filters with one mirror reflecting 100% (also known as Gires-Tournois interferometer). An article of M. Jablonski, Y. Takushima, K. Kikuchi, Y. Tanaka, and N. Higashi, “Adjustable Coupled Two-Cavity Allpass Filter for Dispersion Slope Compensation of Optical Fibres”, Electronics Letters 36(5), pp. 511-512 (2000), (in the following referred to as [1]) discloses an adjustable coupled two-cavity allpass filter for dispersion slope compensation of optical fibers. This device offers one more degree of freedom compared to a simple Gires-Tournois interferometer and enhances the tuning range of the CD.

Planar integrated waveguide technology seems attractive for realizing CD-equalizers since the devices are compact and robust. In the work of C. K. Madsen, “General IIR Optical Filter Design for WDM Applications Using All-Pass Filters”, Journal of Lightwave Technology 18(6), pp. 860-868 (2000), and of C. K. Madsen, G. Lenz, A. J. Bruce, M. A. Capuzzo, L. T. Gomez, T. N., Nielsen, I. Brener, “Multistage dispersion compensator using ring resonators”, Optics Letters 24(22), pp. 1555-1557 (1999), (in the following referred to as [3] and [4]) ring resonators are used to generate group delay variations with frequency. However, this concept is difficult to manufacture since the ring diameters have to be in the order of millimeters.

From DE 198 18 699 A1 it is known an apparatus and a method to minimize signal distortions caused by PMD. This known apparatus comprises two elements with constant DGD which are connected by a polarization controller. However, this system is not able to generate a continuous adjustable amount of DGD over a broad bandwidth. Also first-order and second-order PMD cannot be controlled independently.

Since second-order PMD causes polarization dependent CD, both effects are very closely linked. A device compensating both effects simultaneously is not found in the literature. Such a device would be advantageous with respect to manufacturing costs and insertion loss.

### SUMMARY OF THE INVENTION

Therefore, it is an object of the invention to provide improved optical influencing of an optical signal.

The object is solved by the independent claims.

An advantage of the present invention is that it is possible to perform adaptive control of both, PMD and CD, since the invention gives access to both optical parameters. Moreover, the invention provides simultaneous compensation of CD and OMD, preferably in one device

Preferred embodiments of the present invention are devices with a continuous tunable group delay behavior, referred to as group delay equalizers (GDE). These devices offer the possibility to tune absolute group delay and/or CD. Compared to the prior art they show improvements with respect to the degrees of freedom, tuning speed and cost-efficiency at the same time.

Further preferred embodiments of the present invention describe a modification of these group delay equalizers which turns them into tunable PMD-equalizers. This can be done by simply inserting a small amount of birefringence. Especially tunable PMD-equalizers are often realized by motor-driven moving mirrors which are inferior with respect to reliability and response time. The PMD-equalizers presented in this invention are fast tunable and highly reliable. The operating bandwidth can be adapted to the needs of an optical data signal.

Other preferred embodiments of the present invention are methods offering the possibility to tune PMD and CD simultaneously. This reduces cost for a joint PMD- and CD-compensation and reduces the footprint of the components which is necessary for integration into optical receiver modules.

In the concepts where no gratings are involved, group delay ripples can be reduced to an amount allowing application to high bit-rate systems with bit-rates substantially higher than 40 Gbit/s.

Due to the fast response time of the devices they are able to track the temporal fluctuations of the fiber link at the speed they occur. The time-scale of the PMD fluctuations can be in the order of milliseconds. Thus, prior art solutions based on motor-driven movable mirrors are not suitable in practical applications.

Other preferred embodiments are shown by the dependent claims.

It is clear that the invention can be partly embodied or supported by one or more suitable software programs, which can be stored on or otherwise provided by any kind of data carrier, and which might be executed in or by any suitable data processing unit.

### BRIEF DESCRIPTION OF THE DRAWINGS

Other objects and many of the attendant advantages of the present invention will be readily appreciated and become better understood by reference to the following detailed description when considering in connection with the accompanied drawings. The components in the drawings are not necessarily to scale, emphasis instead being placed upon clearly illustrating the principles of the present invention. Features that are substantially or functionally equal or similar will be referred to with the same reference sign(s).

FIG. 1 shows an Gires-Tournois Interferometer as an optical all-pass filter exhibiting CD;

FIG. 2 shows a group delay spectrum and a dispersion spectrum (R=0.5, DL=0.4 mm), in which figure for comparison a 40 Gbit/s-carrier (bandwidth=0.3 nm) has been added;

FIG. 3 shows the choice of R and DL, (a): usable bandwidth, (b): maximum dispersion value;

FIG. 4a shows an optical all-pass filter using a 50%-beam splitter;

FIG. 4b shows a schematic drawing equivalent to FIG. 4a using a directional coupler;

FIG. 5a shows another filter exhibiting spectral group delay variations;

FIG. 5b shows the interferometer of FIG. 5a, enhanced by two detectors;

FIG. 5c shows the generalized concept of FIGS. 5a and 5b;

FIG. 5cII. shows another embodiment of the invention;

FIG. 6 shows an unfolded setup of FIG. 5a;

FIG. 7 shows a combination of adjustable group delay and dispersion compensation using Bragg gratings;

FIG. 8 shows a Gires-Toumois interferometer as optical all-pass filter, in which an additional wave plate generates PMD;

FIG. 9a shows an optical all-pass filter using a 50%-beam splitter, in which an additional wave plate generates PMD;

FIG. 9b shows a lossy optical all-pass filter using a 50%-beam splitter and a balanced MZI, coupled to an unbalanced Michelson interferometer;

FIG. 10 shows an unfolded setup of FIG. 9b;

FIG. 11 shows a combination of adjustable group delay and dispersion compensation using Bragg gratings, in which an additional wave plate generates PMD;

FIG. 12 shows another device depending on the GDE,

FIG. 13 shows another device depending on the GDE;

FIG. 14 shows the feed-forward structures of FIGS. 12 and 13 with transmissive GDES;

FIG. 15 shows the preceding setups combined with a wavelength dependent polarization transformer for generating wavelength dependent

FIG. 16 shows the feed-forward structure of FIG. 15.

### DETAILED DESCRIPTION OF THE INVENTION

The description of the preferred embodiments of the invention is divided into three parts. The first part describes embodiments for generating optical filters exhibiting an adjustable group delay behavior, in particular group delay, group delay dispersion, group delay dispersion slope or a combination of these (further referred to as group delay equalizers, GDES). The second part describes embodiments of a method how these GDEs can be modified by inserting a certain amount of birefringence (for example a wave plate) which causes the GDEs to exhibit an adjustable amount of PMD. These equalizers can be used in a feedback control system which monitors signal quality and optimizes the settings of the presented equalizers to obtain best transmission quality. The third part describes embodiments which propose the application of a polarization diversity scheme to the GDEs for generation of PMD. This scheme also offers the possibility of generating first-order PMD, second-order PMD and CD simultaneously.

CD can be generated by interference of two or more optical beams (see [1] or [2], which documents are incorporated herein by reference). Due to the interfering beams a spectral dependence of the optical phase and thus CD is generated.

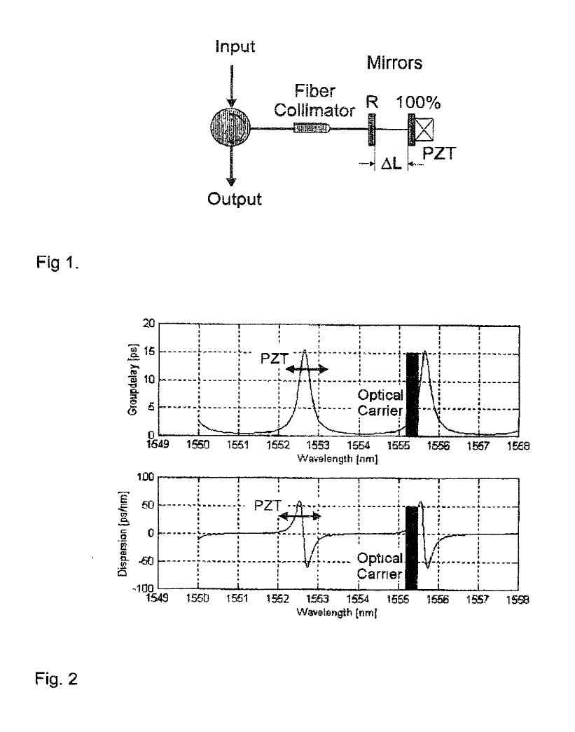

FIG. 1 illustrates one of the simplest optical all-pass filters. It shows an Gires-Tournois interferometer as an optical all-pass filter exhibiting CD.

This device consists of a 100%-mirror and a partial reflector R with a power-reflection coefficient R, ΔL being the distance between the partial reflector R and the 100%-mirror. The device receives an optical beam from a fiber collimator which receives the optical beam from a circulator. The circulator shown on the left hand side of the figure couples out the optical beam from the incoming optical signal, indicated in FIG. 1 by “Input”, and which couples the influenced optical beam back into the optical signal, indicated in FIG. 1 by “Output”.

Tunability of the device is achieved by applying a piezo actuator (PZT) which moves the 100%-mirror by a small amount (typically some micrometers) depending on a control voltage. The transfer function H of this system is given by:

$$H ( j ω ) = \frac{j \sqrt{R} + exp ( - j \frac{2 Δ L}{c} ω )}{1 - j \sqrt{R} exp ( - j \frac{2 Δ L}{c} ω )}$$

If losses are ignored the amplitude of H is always unity. The group delay spectrum τ and the dispersion D can be calculated as follows:

$${τ}_{g} ( ω ) = - \frac{ⅆ arg ( H ( j ω ) )}{ⅆ ω} , D ( ω ) = \frac{ⅆ {τ}_{g}}{ⅆ ω}$$

Due to the resonator-structure the spectra are periodical. If an optical data signal is processed by this device, the periodicity should be greater than the bandwidth of the optical signal. The two design parameters R and ΔL have to be chosen carefully to achieve the desired adjusting range and the desired usable bandwidth.

FIG. 2 shows a simulated group delay spectrum and a dispersion spectrum for R=0.5 and ΔL=0.4 mm. For comparison a 40 Gbit/s-carrier (bandwidth=0.3 nm) has been added.

The whole spectrum can be shifted using the piezo actuator. A small displacement of half of the wavelength λ, i.e. λ/2 (usually some microns), is enough to move the spectrum over a whole period. The spectrally fixed carrier ‘sees’ different dispersion values D depending on the PZT voltage, in this way a dynamic equalization of the total link dispersion can be achieved.

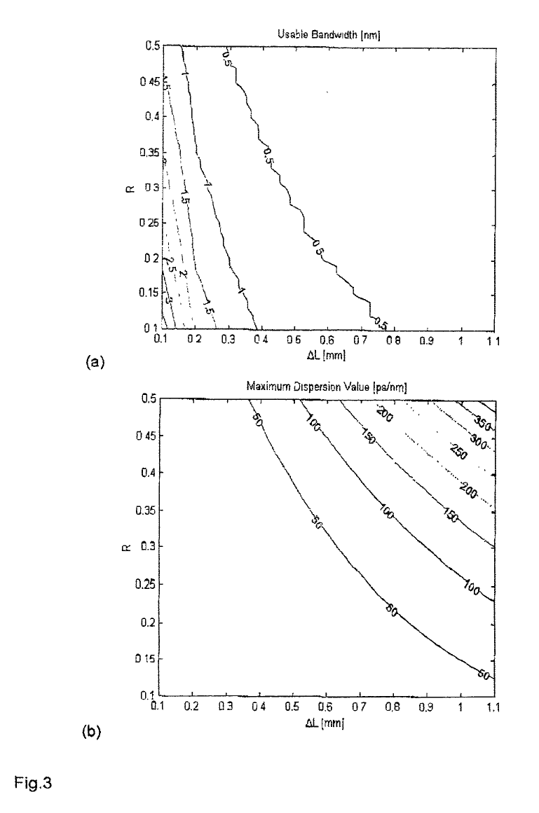

The choice of R and ΔL is a trade-off between the usable bandwidth and the adjusting range of the dispersion. As a measure for the usable bandwidth one can choose the part of the spectrum where the dispersion shows quasi-linear behavior (in FIG. 2 for example 1555,0 nm . . . 1555,5 nm). FIGS. 3a and 3b shows a contour plot of the usable bandwidth and the maximum achievable dispersion value D for different values of R and ΔL, FIGS. 3(a): usable bandwidth, (b): maximum dispersion value D.

The choice of R=0.5 and ΔL=0.4 mm seems optimal for a 40 Gbit/s signal. It offers a tuning range of 100 ps/nm (−50 . . . 50 ps/nm).

In the following, at first, there are interferometers described which are embodiments of the method and the apparatus of the invention.

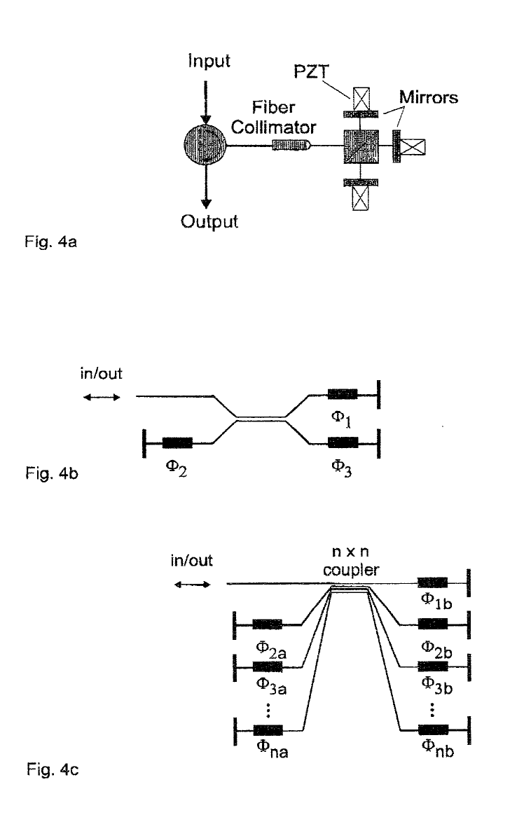

FIG. 4a shows a possible embodiment which is able to provide an adjustable group delay and an adjustable dispersion. Tunability is provided by the piezo actuators (PZT). The more complex structure of this optical all-pass filter is realized by introducing a 50%-beam splitter receiving the beam provided by a circulator and a fiber collimator. The shown beam splitter splits the beam into n=2 parts, splits all of the n=2 parts into m=2 subparts after each part having being reflected by the 100%-mirrors, and superimposes the first subpart of the m=2 subparts to a resulting first superimposed part. This superposition is performed for the second subpart of the m=2 subparts, also, resulting in a second superimposed part. Subsequently, with the second superimposed part the procedure is repeated. However, the first subpart being provided by a providing device, here the circulator, to the optical signal for influencing the group delay of the optical signal.

This embodiment of the invention offers one more degree of freedom compared to the Gires-Toumois interferometer. The additional degree of freedom gives the possibility not only to change the spectral position of the group delay curve but also to manipulate its shape. The spectral behavior can be calculated similar to the behavior of FIG. 1.

FIG. 4b shows an schematic drawing using a directional coupler, being equivalent to the beam splitter of FIG. 4a. The PZTs appear here as phase modulators φ1, φ2, φ3. The mirrors are fixed.

To increase the degrees of freedom furthermore, we propose to use a directional coupler with 2n ports (n×n-coupler) as shown in FIG. 4c. At each port a mirror combined with a phase modulator is located. Such a device is also an optical all-pass and can generate complex group delay and dispersion functions, similarly performing the same claimed steps as the embodiment of FIG. 4a for higher values of m and n.

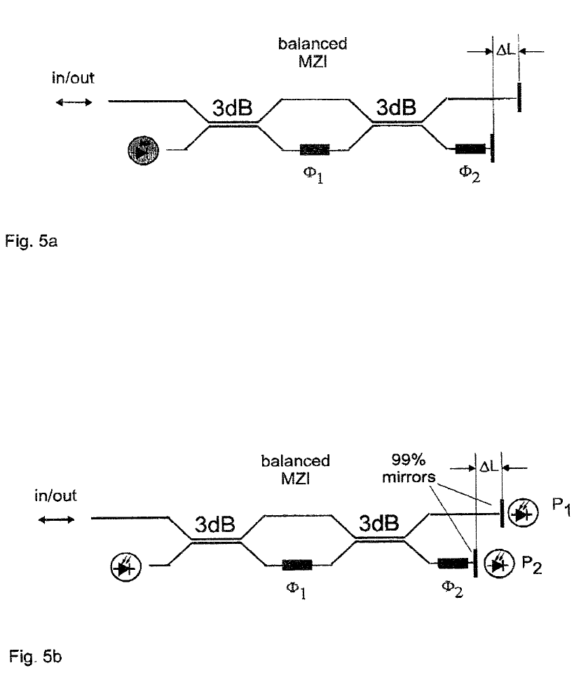

FIG. 5a shows another embodiment of the invention. This embodiment provides spectral group delay variations. It provides an adjustable group delay while the dispersion is zero at the operating wavelength. Since there is one port without a mirror, it is not an all-pass filter. At this place an optical detector as shown in FIG. 5a can be used to control the phase modulators in a way that the power at this port is minimized. Then all power is reflected back into the input port. The figure shows a lossy optical filter using a balanced Mach-Zehnder interferometer, coupled to an unbalanced Michelson interferometer using two 3 dB beam splitter or couplers and two phase modulators φ1, φ2.

FIG. 5b shows the interferometer of FIG. 5a, enhanced by two detectors P1 and P2 behind partly (here 1%) transparent mirrors. By measuring the powers P1 and P2 the current device status can be determined.

The basic idea of this interferometer is to use the balanced Mach-Zehnder interferometer (balanced MZI) to direct the light either to the first (before P1) or to the second mirror (before P2). The light path to one of the mirrors is longer than to the other. Thus, if the light is reflected at the near mirror (before P2), the group delay is smaller compared to the case where the light is reflected by the far mirror (before P1). The phase modulator φ1 can be used to choose one of both cases. It turns out that it is possible to adjust the phase modulator φ1 to a value between these two discrete cases allowing to adjust any delay value between the near and the far reflection.

Because of environmental changes, in many implementations the exact state of the phase modulators φ1, φ2 as a function of the applied voltage is not known. Especially the state of φ1 is important to know since it defines the current group delay of the device. The aforementioned setup can be enhanced by using partial reflecting mirrors. In FIG. 5b 99%-mirrors are used to let some (here 1%) of the optical power pass onto two detectors P1, P2. The detected powers P1, P2 are a measure for the current device status and can be used to determine the current group delay.

FIG. 5c shows a generalized concept of the setup in FIGS. 5a and 5b. The 4-port directional couplers are replaced by 2n-port directional couplers. In this way the degrees of freedom can be increased and thus the accuracy of how the desired group delay behavior can be equalized.

Since the reflective nature of this device causes additional cost for a circulator, indicated by “in/out” in FIG. 5a, it may be advantageous to unfold the setup of FIG. 5a and use the MZIs in forward direction.

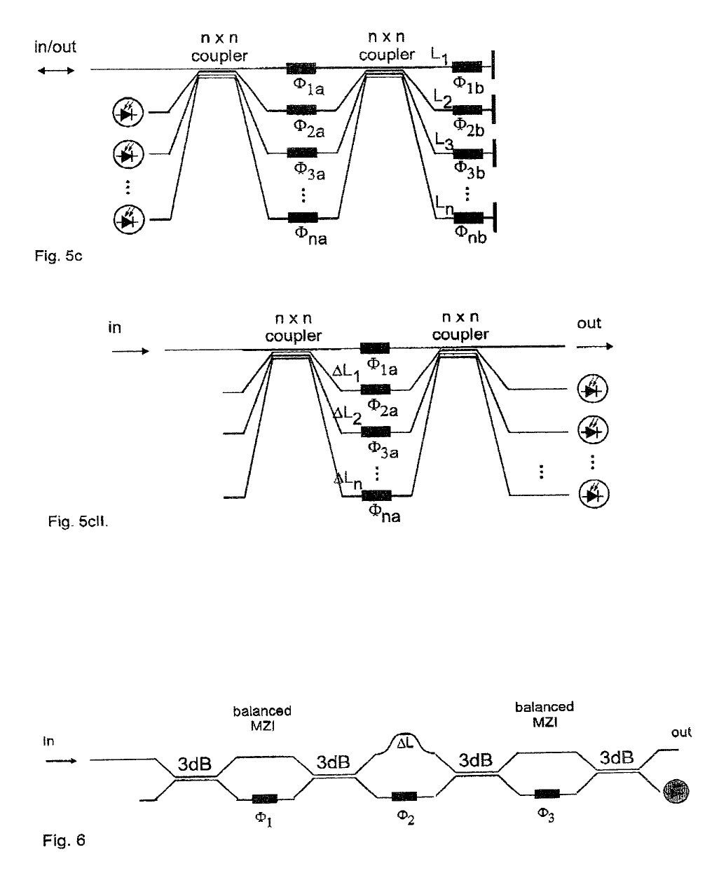

This unfold embodiment is shown in FIG. 6. To achieve the same behavior as in the previous setup the phase modulators φ1 and φ3 have to be adjusted to the same value.

Group delay equalization with many degrees of freedom can also be realized with the embodiment according to a setup shown in FIG. 5c.II. The settings of the phase modulators φ1a, φ2a, φ3a, . . . , φna as well as the lengths of the optical paths, partly extended by ΔL, have to be carefully chosen to provide the desired group delay behavior including tunability. The detectors at the unused ports on the right hand side of FIG. 5cII. can be used to find the optimum settings of the phase modulators φ1a, φ2a, φ3a, . . . , φna with the lowest insertion loss and amplitude distortion.

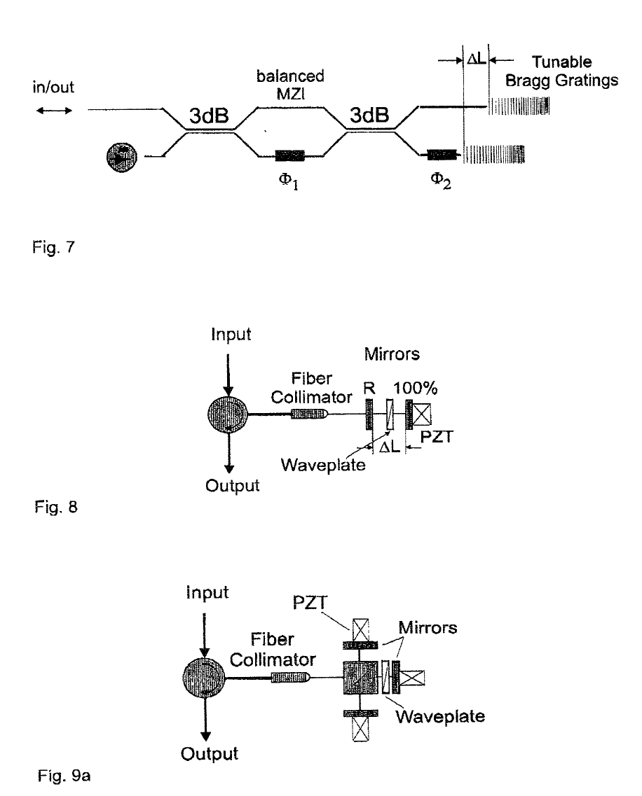

It is possible to replace the mirrors in FIGS. 5a or 5b by Bragg gratings. This may be advantageous if the device is realized in planar integrated technology. Furthermore, Bragg gratings can be tuned by mechanical stress or heating elements [5], [6], which documents are incorporated herein by reference. If chirped Bragg gratings are used according to FIG. 7 the device can be used to provide an adjustable amount of dispersion compensation in addition to an adjustable group delay compensation.

The previous setups are not polarization sensitive. In order to generate an adjustable amount of PMD (i.e. for adaptive PMD compensation) a polarization dependence of the group delay can be added. This can easily be done by inserting a waveplate into the above-described embodiments. Such a waveplate introduces a difference between horizontal and vertical polarized light and thus generates PMD. This concept can be applied to all previous setups.

FIG. 8 shows a Gires-Tournois interferometer as optical all-pass filter according to FIG. 1 with an additional wave plate generating PMD.

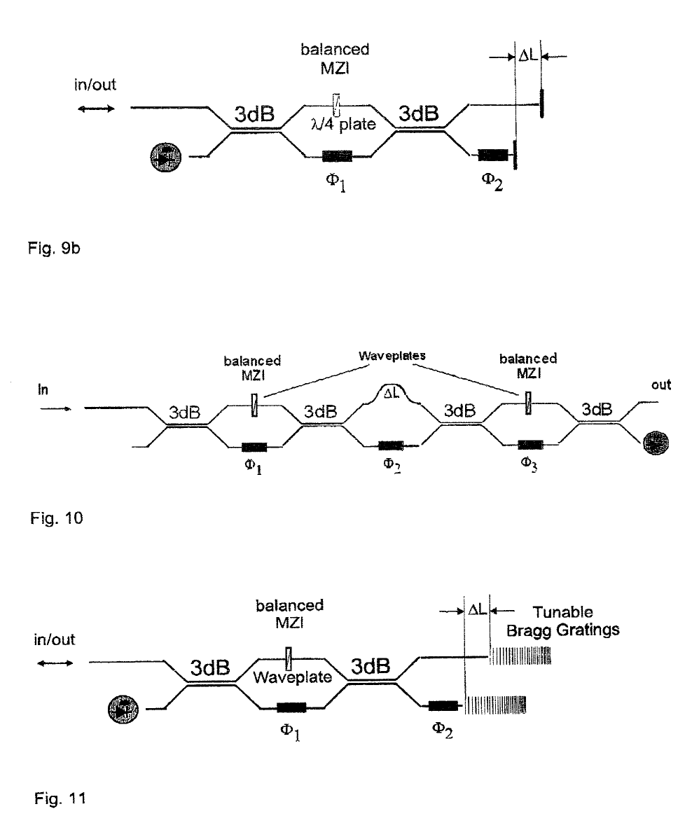

FIG. 9a shows an optical all-pass filter using a 50%-beam splitter according to FIG. 4a, in which an additional wave plate generates PMD.

FIG. 9b shows a lossy optical all-pass filter using a 50%-beam splitter and a balanced MZI, coupled to an unbalanced Michelson interferometer. A quarter wave plate generates a difference between orthogonal polarized waves and thus PMD.

FIG. 10 shows an unfolded setup of FIG. 9b, the function of this device being equivalent to the embodiment of FIG. 9b.

FIG. 11 shows a combination of adjustable group delay and dispersion compensation using Bragg gratings. An additional wave plate generates PMD.

Instead of inserting a birefringent element into a GDE the commonly known polarization diversity scheme can be used to generate PMD. Therefore the signal is split into two orthogonal polarizations using a polarization beam splitter. The two emerging signals have a known polarization state. Thus, the input polarization of subsequent devices is well defined and the problems of the prior art associated with birefringence of planar optical components can be avoided.

The following figures show setups using the polarization diversity scheme. In these figures a reflective GDE is assumed which can generate an adjustable amount of group delay, group delay dispersion, group delay dispersion slope or a combination of these. The GDEs may be realized by the embodiments described above.

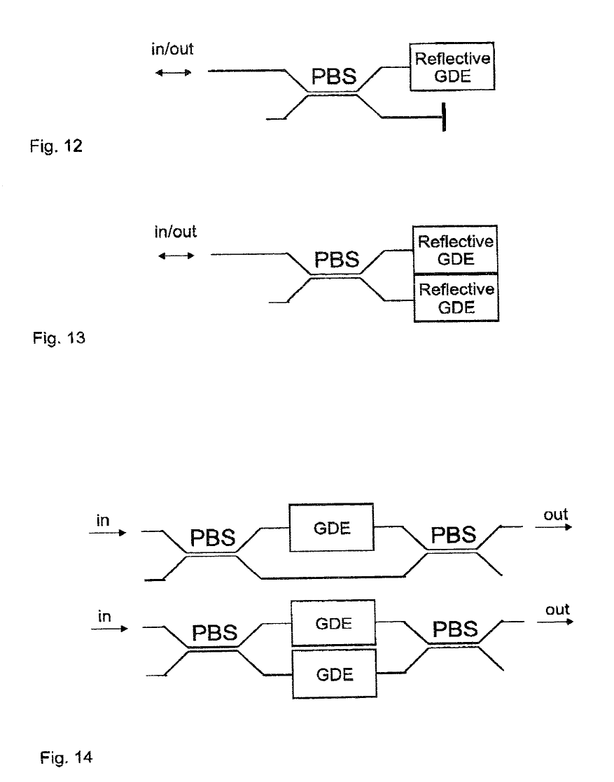

FIG. 12 shows another device depending on the GDE, this device can show first-order PMD and second-order PMD.

FIG. 13 shows another device depending on the GDEs, this device can show first-order PMD, second-order PMD and CD

The setups depicted in FIG. 12 and FIG. 13 offer a great number of degrees of freedom described in the following paragraphs. The device in FIG. 12 can show first-order PMD if the GDE allows to adjust its group delay, if it allows to adjust its CD then the system's DGD becomes wavelength dependent which usually is associated with second-order PMD. The device is not able to generate CD since in the second arm a non-dispersive mirror is used.

Due to the second GDE, the device in FIG. 13 can generate CD. The difference between the group delay curves of the two GOEs yields the DGD and the common part of the group delay curves yields the CD.

If transmissive GOEs are used, the setups of FIGS. 12 and 13 can be turned into a feed-forward structure without changing the behavior (see FIG. 14).

FIG. 14 shows the feed-forward structures of FIGS. 12 and 13 with transmissive GDEs.

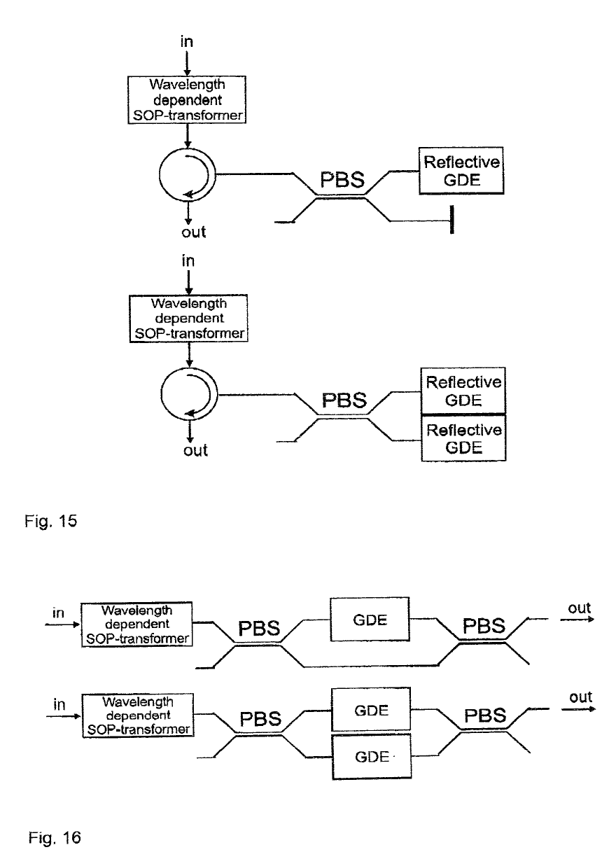

Some of the preceding devices show to some extend second-order PMD. In fact this is a special case of second-order PMD where the DGD varies with wavelength. The principal states (PSP) are not wavelength-dependent and are defined by the orientation of the PBS. To achieve a better approximation of the PMD of a fiber link it might be necessary to generate both: wavelength dependent DGD and wavelength dependent PSP. This can be achieved with a setup of either FIGS. 12, 13 or 14 combined with a wavelength-dependent polarization transformer (FIGS. 15 and 16).

FIG. 15 shows the preceding setups combined with a wavelength dependent polarization transformer can generating wavelength dependent PSPs.

FIG. 16 shows the feed-forward structure of FIG. 15.

1. A method of influencing a group delay of an optical signal, comprising the steps of:
a: splitting a beam of the optical signal into n parts, each part traveling an optical path, n being a natural number greater zero,
b: splitting all of the n parts into m subparts, each part traveling an optical path, m being a natural number greater zero,
c: superimposing the kth subpart of at least two of the m subparts to a resulting kth superimposed part, k=1,
d: repeating step c for k from 2 to m,
e: performing steps b to d at least one time with at least two of the superimposed parts,
f: using at least one of the resulting superimposed parts for influencing the group delay of the optical signal.

2. The method of claim 1, further comprising the step of:
using the same splitting point for at least two of the splittings or superimposings.

3. The method of the claims 1 or 2, further comprising the step of:
using different optical path lengths with at least two of the optical paths of the n parts and/or of the m subparts.

4. The method of any one of the claims 1-3, further comprising the step of:
wavelength dependent filtering of at least one part and/or subpart.

5. The method of claim 4,
wherein the filtering being a change of the group delay, a polarization transformation, a change of a phase and/or a change of an amplitude of the optical signal.

6. The method of any one of the claims 4 or 5, further comprising the step of:
adjusting the filtering to a predetermined value.

7. The method of any one of the claims 1-6, further comprising the step of:
using at least a fraction of at least one of the parts and/or subparts and/or resulting superimposed parts for detecting the power of this part and/or subpart and/or resulting superimposed part.

8. The method of any one of the claims 1-7, further comprising the step of:
using a beam having a defined polarization.

9. The method of any one of the claims 1-8, further comprising the step of:
using at least one of the parts not used in step f for performing steps b to e at least one more time.

10. The method of any one of the claims 1-9, further comprising the step of:
using the adjusting of the filtering for compensating at least one directly or indirectly detected unwanted value of a property of the optical signal.

11. The method of the claim 10,
the property being chromatic dispersion or polarization mode dispersion.

12. A software program or product, preferably stored on a data carrier, for executing the method of one of the claims 1 to 11 when run on a data processing system such as a computer.

13. An apparatus for equalizing a group delay of an optical signal, comprising:
at least one first beam splitter for splitting a beam of the optical signal into n parts, each part traveling an optical path, n being a natural number greater zero,
at least one subunit, comprising:
at least one second beam splitter for splitting all of the n parts into m subparts, each part traveling an optical path, m being a natural number greater zero,
at least one third beam splitter for superimposing the kth subpart of at least two of the m subparts to a resulting kth superimposed part, k=1 to m,
a providing device for providing at least one of the resulting superimposed parts for influencing the group delay of the optical signal.

14. The apparatus of claim 13,
wherein at least two of the beam splitters being a single beam splitter.

15. The apparatus of the claims 13 or 14, further comprising:
a manipulating unit for providing different optical path lengths to at least two of the optical paths of the n parts and/or of the m subparts.

16. The apparatus of claim 15,
wherein the manipulating unit comprises at least one of the following: a fiber-extension, a mirror, a Faraday-mirror, a Bragg-grating, a phase-modulator, a phase retarder.

17. The apparatus of claim 15 or 16,
wherein the manipulating unit being movable.

18. The apparatus of any one of the claims 15-17,
wherein the manipulating unit being partly transparent for using at least a fraction of at least one of the parts and/or subparts and/or resulting superimposed parts,
the manipulating unit comprising at least one detector for detecting the power of this part and/or subpart and/or resulting superimposed part.

19. The apparatus of any one of the claims 13-18, further comprising:
at least one wavelength dependent filter for filtering at least one part and/or subpart.

20. The apparatus of claim 19, further comprising:
wherein the filtering being a change of the group delay, a polarization transformation, a change of a phase and/or a change of an amplitude of the optical signal.

21. The apparatus of claims 19 or 20, further comprising;
the filter comprising at least one of the following: a fiber-extension, a mirror, a Faraday-mirror, a Bragg-grating, a phase-modulator, a phase retarder.

22. The apparatus of any one of the claims 19-21, further comprising:
at least one polarization beam splitter for providing a beam having a defined polarization.

23. The apparatus of any one of the claims 13-22, further comprising:
at least one mirror for using at least one of the parts not used by the providing device to provide this at least one part to the at least one subunit at least one more time.

24. The apparatus of any one of the claims 13-23, further comprising:
an adjusting device for adjusting the filtering to a predetermined value.

25. The apparatus of claim 24, further comprising:
a detector for directly or indirectly detecting an unwanted value of a property of the optical signal,
a deriving unit for deriving the predetermined value from the detected unwanted value,
a compensator for compensating the unwanted value of the property by using the adjusting of the filtering to the predetermined value.

26. The apparatus of claim 25, further comprising:
the property being chromatic dispersion or polarization mode dispersion.
